(19) United States
(12) Patent Application Publication
(10) Pub. No.: US 2018/0105677 A1
(43) Pub. Date: Apr. 19, 2018

(54) COLORING PROCESS FOR POLY(METH)ACRYLATES WITH WATER-BASED LIQUID DYES, AND WATER-BASED LIQUID DYES

(71) Applicants: Ursula GOLCHERT, Dieburg (DE); Klaus SCHULTES, Wiesbaden (DE); Stefan NAU, Buettelborn (DE); Ernst BECKER, Bensheim (DE); Manuel KAISER, Leverkusen (DE); Juergen GROENEN, Overath (DE); Daniel CLEFF, Bad Arolsen (DE); Viola ROSNER, Burscheid (DE); Norbert BENDZKO, Leverkusen (DE)

(72) Inventors: Ursula GOLCHERT, Dieburg (DE); Klaus SCHULTES, Wiesbaden (DE); Stefan NAU, Buettelborn (DE); Ernst BECKER, Bensheim (DE); Manuel KAISER, Leverkusen (DE); Juergen GROENEN, Overath (DE); Daniel CLEFF, Bad Arolsen (DE); Viola ROSNER, Burscheid (DE); Norbert BENDZKO, Leverkusen (DE)

(21) Appl. No.: 15/842,919

(22) Filed: Dec. 15, 2017

Related U.S. Application Data
(62) Division of application No. 14/804,449, filed on Jul. 21, 2015, now abandoned.
Application No. 14/804,449 is a division of application No. 13/058,364, filed on Feb. 10, 2011, now abandoned.

(30) Foreign Application Priority Data
Aug. 19, 2008 (DE) 10 2008 041 338.0

(51) Int. Cl. C08K 5/23; C08K 5/01; C08L 33/04

(52) U.S. Cl. CPC C08K 5/235; C08K 5/01; C08K 2003/3027; C08L 33/04

(57) ABSTRACT

The invention relates to an aqueous colorant preparation for coloring thermoplastic plastics.

### CROSS-REFERENCE TO RELATED APPLICATIONS

This application is a divisional of U.S. application Ser. No. 14/804,449 filed Jul. 21, 2015, pending, which is a divisional of U.S. application Ser. No. 13/058,364 filed Feb. 10, 2011, which is a National Stage of PCT/EP/09/058784 filed Jul. 10, 2009 and claims the benefit of DE 10 2008 041 338.0 filed Aug. 19, 2008.

### FIELD OF THE INVENTION

The invention relates to a process for colouring thermoplastic polymer moulding materials with aqueous colorant preparations, the polymer moulding material used being, for example, a polymethyl (meth)acrylate moulding material. The invention further relates to a waterborne colorant preparation.

### PRIOR ART

U.S. Pat. No. 3,956,008 describes a liquid dispersion for colouring plastics articles, consisting of inorganic particles of size between 2 and 50 μm and a surface-active system composed of sorbitol esters. Aqueous systems are not described.

U.S. Pat. No. 3,992,343 (Degussa) describes an aqueous dispersion system consisting of organic or inorganic pigment particles, water and a dispersant, the dispersant being very specific.

U.S. Pat. No. 4,091,034 describes a blue, water-soluble dye formulation of a triphenylmethane dye. It is used in the form of an aqueous dispersion to colour textiles.

U.S. Pat. No. 4,167,503 describes a liquid formulation based on a carrier composed of a polyoxyethylene derivative, PEG and a further additive. Water is not used as a solvent.

U.S. Pat. No. 4,169,203 describes water-soluble polymeric pigments which consist of a nonchromophoric polymeric skeleton and chromophoric groups chemically bonded thereto.

U.S. Pat. No. 4,341,565 describes a liquid dye formulation composed of solid pigment, a liquid phase composed of esters of long-chain alcohols and long-chain acids, and a gelating assistant.

U.S. Pat. No. 4,871,416 likewise describes organic-based formulations.

U.S. Pat. No. 4,634,471 describes formulations comprising organic solvents.

U.S. Pat. No. 4,804,719 describes a water-dispersible formulation comprising a polymer.

U.S. Pat. No. 4,910,236 describes a printing ink formed from an aqueous emulsion composed of water and emulsifier and an organic phase composed of olefinic resins and pigment. In a subsequent step, the water is removed from the formulation.

U.S. Pat. No. 5,043,376 describes a nonaqueous system.

U.S. Pat. No. 5,104,913 constitutes a partial application of U.S. Pat. No. 5,043,376 and describes a process for preparing an aqueous dye dispersion, oil in water.

U.S. Pat. No. 5,308,395 likewise describes an organic solution.

A hydrophilic colorant and water are shaped in U.S. Pat. No. 5,328,506 to a paste, which can be processed further with the customary tools and machines in dye production.

U.S. Pat. No. 5,759,472 describes a process for shaping polymers, consisting of the following steps: preparation of a colour mixture from a carrier (10-75%), water (0-15%), a dispersant (0.1-10%) and a colorant (10-80%). In addition, polyols may also be present. In a further process step, a pulverulent polymer is provided, then the carrier system is mixed with the polymer powder and processed to give the mixture (PE). A subclaim is directed to the amount of 1-14% water.

U.S. Pat. No. 6,428,733 describes a volatile system; it comprises a mixture of glycerol and water.

U.S. Pat. No. 6,649,122 describes a process for colouring thermoplastic polymers, in which 10 to 80 percent colorant and not more than 30 percent dispersant are used; the remainder is water as the solvent. The dispersants used are polyvinylpyrrolidones, for example Sokolan® HP50 (BASF) or neutralized polyacrylic acids, salts of lignosulphonic acids, of naphthalenesulphonic acids or of the polymeric carboxylic acids. Preference is given to using nonionic dispersants, for example nonylphenol or octylphenol.

A disadvantage of the prior art solutions is the more or less intensive use of organic solvents in the colorant formulation. The use of organic solvents in polymer moulding materials leads to a rise in the concentration of low molecular weight organic compounds in the polymer and hence to a deterioration in the properties of the polymers, for example lowering of the Vicat softening temperature, or to a higher stress cracking susceptibility of the articles produced from the polymers.

The liquid dyes available on the market generally comprise fatty acid esters or white oils as binders, which remain in the polymer after the colouring and lead to a lowering of the Vicat softening temperature. In addition, deposit formations can be observed in injection moulding.

### Problem

It is therefore an object of the present invention to provide an aqueous colorant preparation and a process for colouring thermoplastic polymer moulding materials, which does not have the disadvantages of the prior art outlined above and which can be used as a problem-free replacement for the colouring of thermoplastic polymer moulding materials.

The thermoplastic polymer moulding material used is, for example, a polymethyl (meth)acrylate moulding material or a polycarbonate moulding material.

Polymethyl (meth)acrylate moulding materials are understood hereinafter to mean polymer moulding materials composed of polymerized alkyl methacrylate and of polymerized alkyl acrylate, and of mixtures of the two monomer types.

### Solution

The object is achieved by an aqueous colorant preparation using a polyacrylate emulsifier according to claim 1. The coloured thermoplastic polymer moulding material and W polymer mouldings producible therefrom are protected in the subsequent claims.

The invention relates to an aqueous colorant preparation for colouring thermoplastic polymer moulding materials, characterized in that it comprises
1% by weight to 49% by weight of a modified polyacrylate,
0.5% by weight to 50% by weight of a pigment mixture and
0% by weight to 50% by weight of the customary assistants and
demineralized water, where the portions by weight of the components add up to 100% by weight.

By virtue of the use of the inventive aqueous colorant preparation, it is possible in a surprising and unexpected manner, in addition to good colouring of the thermoplastic polymer moulding material, also to keep constant or even increase the Vicat softening temperature of the polymer moulding produced from the coloured thermoplastic polymer moulding material. The remaining mechanical properties of the polymer mouldings remain unchanged.

Performance of the Invention

The thermoplastic polymer moulding materials and preparation thereof

Polymethyl (meth)acrylates are generally obtained by free-radical polymerization of mixtures which comprise methyl methacrylate. In general, these mixtures contain at least 40% by weight, preferably at least 60% by weight and more preferably at least 80% by weight, based on the weight of the monomers, of methyl methacrylate.

In addition, these mixtures for preparing polymethyl (meth)acrylates may comprise further (meth)acrylates which are copolymerizable with methyl methacrylate. The expression “(meth)acrylates” includes methacrylates and acrylates and mixtures of the two.

These monomers are widely known. They include (meth)acrylates which derive from saturated alcohols, for example methyl acrylate, ethyl (meth)acrylate, propyl (meth)acrylate, n-butyl (meth)acrylate, tert-butyl (meth)acrylate, pentyl (meth)acrylate and 2-ethylhexyl (meth)acrylate; (meth)acrylates which derive from unsaturated alcohols, for example oleyl (meth)acrylate, 2-propynyl (meth)acrylate, allyl (meth)acrylate, vinyl (meth)acrylate; aryl (meth)acrylates such as benzyl (meth)acrylate or phenyl (meth)acrylate, where the aryl radicals may each be unsubstituted or up to tetrasubstituted; cycloalkyl (meth)acrylates such as 3-vinylcyclohexyl (meth)acrylate, bornyl (meth)acrylate; hydroxylalkyl (meth)acrylates such as 3-hydroxypropyl (meth)acrylate, 3,4-dihydroxybutyl (meth)acrylate, 2-hydroxyethyl (meth)acrylate, 2-hydroxypropyl (meth)acrylate; glycol di(meth)acrylates such as 1,4-butanediol (meth)acrylate, (meth)acrylates of ether alcohols, such as tetrahydrofurfuryl (meth)acrylate, vinyloxyethoxyethyl (meth)acrylate; amides and nitriles of (meth)acrylic acid, such as N-(3-dimethylaminopropyl)-(meth)acrylamide, N-(diethylphosphono)(meth)acrylamide, 1-methacryloylamido-2-methyl-2-propanol; sulphur-containing methacrylates such as ethylsulphinylethyl (meth)acrylate, 4-thiocyanatobutyl (meth)acrylate, ethylsulphonylethyl (meth)acrylate, thiocyanatomethyl (meth)acrylate, methylsulphinylmethyl (meth)acrylate, bis((meth)acryloyloxyethyl) sulphide; polyfunctional (meth)acrylates such as trimethylolpropane tri(meth)acrylate.

In addition to the (meth)acrylates detailed above, the compositions to be polymerized may also comprise further unsaturated monomers which are copolymerizable with methyl methacrylate and the aforementioned (meth)acrylates.

These include 1-alkenes such as hexene-1, heptene-1; branched alkenes, for example vinylcyclohexane, 3,3-dimethyl-1-propene, 3-methyl-1-diisobutylene, 4-methylpentene-1; acrylonitrile; vinyl esters such as vinyl acetate; styrene, substituted styrenes with an alkyl substituent in the side chain, for example α-methylstyrene and α-ethylstyrene, substituted styrenes with an alkyl substituent on the ring, such as vinyltoluene and α-methylstyrene, halogenated styrenes, for example monochlorostyrenes, dichlorostyrenes, tribromostyrenes and tetrabromostyrenes; heterocyclic vinyl compounds such as 2-vinylpyridine, 3-vinylpyridine, 2-methyl-5-vinylpyridine, 3-ethyl-4-vinylpyridine, 2,3-dimethyl-5-vinylpyridine, vinylpyrimidine, vinylpiperidine, 9-vinylcarbazole, 3-vinylcarbazole, 4-vinylcarbazole, 1-vinylimidazole, 2-methyl-1-vinylimidazole, N-vinylpyrrolidone, 2-vinylpyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinylthiazoles and hydrogenated vinylthiazoles, vinyloxazoles and hydrogenated vinyloxazoles;

vinyl and isoprenyl ethers; maleic acid derivatives, for example maleic anhydride, methylmaleic anhydride, maleinimide, methylmaleinimide; and dienes, for example divinylbenzene.

In general, these comonomers are used in an amount of 0% by weight to 60% by weight, preferably 0% by weight to 40% by weight and more preferably 0% by weight to 20% by weight, based on the weight of the monomers, the compounds being useable individually or as a mixture.

The polymerization is generally initiated with known free-radical initiators. The preferred initiators include the azo initiators widely known in the technical field, such as AIBN and 1,1-azobiscyclohexanecarbonitrile, and peroxy compounds such as methyl ethyl ketone peroxide, acetylacetone peroxide, dilauryl peroxide, tert-butyl per-2-ethylhexanoate, ketone peroxide, methyl isobutyl ketone peroxide, cyclohexanone peroxide, dibenzoyl peroxide, tert-butyl peroxybenzoate, tert-butyl peroxyisopropylcarbonate, 2,5-bis(2-ethylhexanoylperoxy)-2,5-dimethylhexane, tert-butyl peroxy-2-ethylhexanoate, tert-butyl peroxy-3,5,5-trimethylhexanoate, dicumyl peroxide, 1,1-bis(tert-butyl-peroxy)cyclohexane, 1,1-bis(tert-butylperoxy)-3,3,5-trimethylcyclohexane, cumene hydroperoxide, tert-butyl hydroperoxide, bis(4-tert-butylcyclohexyl) peroxydicarbonate, mixtures of two or more of the aforementioned compounds with one another and mixtures of the aforementioned compounds with unspecified compounds which can likewise form free radicals.

These compounds are frequently used in an amount of 0.01% by weight to 10% by weight, preferably of 0.5% by weight to 3% by weight, based on the weight of the monomers.

It is possible here to use different poly(meth)acrylates which differ, for example, in terms of molecular weight or in terms of monomer composition.

Impact-Modified Poly(Meth)Acrylate Polymer

The impact-modified poly(meth)acrylate polymer consists of 20 to 80% and preferably 30 to 70% by weight of a poly(meth)acrylate matrix, and 80 to 20% and preferably 70 to 30% by weight of elastomer particles having a mean particle diameter of 10 to 150 nm (measurements, for example, by the ultracentrifuge method).

The elastomer particles distributed within the poly(meth)acrylate matrix preferably have a core with a soft elastomer phase and a hard phase bonded thereto.

The impact-modified poly(meth)acrylate polymer (imPMMA) consists of a proportion of matrix polymer, polymerized from at least 80% by weight of methyl methacrylate units and optionally 0 to 20% by weight of units of monomers copolymerizable with methyl methacrylate, and a proportion, distributed in the matrix, of impact modifiers based on crosslinked poly(meth)acrylates.

The matrix polymer consists especially of 80% by weight to 100% by weight, preferably to an extent of 90% by weight-99.5% by weight, of free-radically polymerized methyl methacrylate units, and optionally to an extent of 0% by weight-20% by weight, preferably to an extent of 0.5% by weight-10% by weight, of further free-radically polymerizable comonomers, e.g. C₁- to C₄-alkyl (meth)acrylates, especially methyl acrylate, ethyl acrylate or butyl acrylate. The mean molecular weight M_{w} (weight average) of the matrix is preferably within the range from 90 000 g/mol to 200 000 g/mol, especially 100 000 g/mol to 150 000 g/mol (determination of M_{w} by means of gel permeation chromatography with reference to polymethyl methacrylate as the calibration standard). The molecular weight M_{w} can be determined, for example, by gel permeation chromatography or by a scattered light method (see, for example, H. F. Mark et al., Encyclopedia of Polymer Science and Engineering, 2nd Edition, Vol. 10, pages 1 ff., J. Wiley, 1989).

Preference is given to a copolymer composed of 90% by weight to 99.5% by weight of methyl methacrylate and 0.5% by weight to 10% by weight of methyl acrylate. The Vicat softening temperatures VET (ISO 306-B50) may be within the range of at least 90, preferably of 95, to 112° C.

The Impact Modifier

The polymethacrylate matrix comprises an impact modifier which may, for example, be an impact modifier of two- or three-shell structure.

Impact modifiers for polymethacrylate polymers are sufficiently well known. Preparation and structure of impact-modified polymethacrylate moulding materials are described, for example, in EP-A 0 113 924, EP-A 0 522 351, EP-A 0 465 049 and EP-A 0 683 028.

Impact Modifier

The polymethacrylate matrix contains 1% by weight to 30% by weight, preferably 2% by weight to 20% by weight, more preferably 3% by weight to 15% by weight, especially 5% by weight to 12% by weight, of an impact modifier, which is an elastomer phase composed of crosslinked polymer particles. The impact modifier is obtained in a manner known per se by bead polymerization or by emulsion polymerization.

In the simplest case, the impact modifiers are crosslinked particles which are obtainable by means of bead polymerization and have a mean particle size in the range from 10 to 150 nm, preferably 20 to 100 and especially 30 to 90 nm. These consist generally of at least 40% by weight, preferably 50% by weight-70% by weight, of methyl methacrylate, 20% by weight to 40% by weight, preferably 25% by weight to 35% by weight, of butyl acrylate, and 0.1% by weight to 2% by weight, preferably 0.5% by weight to 1% by weight, of a crosslinking monomer, for example a polyfunctional (meth)acrylate, for example allyl methacrylate, and optionally further monomers, for example 0% by weight to 10% by weight, preferably 0.5% by weight to 5% by weight, of C₁-C₄-alkyl methacrylates, such as ethyl acrylate or butyl methacrylate, preferably methyl acrylate, or other vinylically polymerizable monomers, for example styrene.

Preferred impact modifiers are polymer particles which may have a two-shell or a three-shell core-shell structure and are obtained by emulsion polymerization (see, for example, EP-A 0 113 924, EP-A 0 522 351, EP-A 0 465 049 and EP-A 0 683 028). Suitable particle sizes of these emulsion polymers must, however, for the purposes of the invention, be within the range of 10-150 nm, preferably 20 to 120 nm, more preferably 50-100 nm.

A three-layer or three-phase structure with a core and two shells may be configured as follows. An innermost (hard) shell may, for example, consist essentially of methyl methacrylate, minor proportions of comonomers, for example ethyl acrylate, and a crosslinker fraction, for example allyl methacrylate. The middle (soft) shell may be formed, for example, from butyl acrylate and optionally styrene, while the outermost (hard) shell usually corresponds essentially to the matrix polymer, which brings about compatibility and good attachment to the matrix. The polybutyl acrylate content in the impact modifier is crucial for the impact-modifying action and is preferably in the range from 20% by weight to 40% by weight, more preferably in the range from 25% by weight to 35% by weight.

Impact-Modified Polymethacrylate Moulding Materials

In an extruder, the impact modifier and matrix polymer can be mixed in the melt to form impact-modified polymethacrylate moulding materials. The material discharged is generally first cut to granules. The latter can be processed further by means of extrusion or injection moulding to give shaped bodies, such as slabs or injection mouldings.

Two-Phase Impact Modifier According to EP 0 528 196 A1

Preferably, especially for film production, but not restricted thereto, a system known in principle from EP 0 528 196 A1 is used, which is a two-phase, impact-modified polymer composed of:
a1) 10 to 95% by weight of a continuous hard phase with a glass transition temperature T_{mg} above 70° C., composed of
a11) 80 to 100% by weight (based on a1) of methyl methacrylate and
a12) 0 to 20% by weight of one or more further ethylenically unsaturated, free-radically polymerizable monomers, and
a2) 90 to 5% by weight of a tough phase with a glass transition temperature T_{mg} below −10° C. distributed in the hard phase, and composed of
a21) 50 to 99.5% by weight of a C₁-C₁₀-alkyl acrylate (based on a2),
a22) 0.5 to 5% by weight of a crosslinking monomer having two or more ethylenically unsaturated, free-radically polymerizable radicals, and
a23) optionally further ethylenically unsaturated, free-radically polymerizable monomers,

at least 15% by weight of the hard phase a1) being bonded covalently to the tough phase a2).

The two-phase impact modifier can be obtained by a two-stage emulsion polymerization in water, as described, for example, in DE-A 38 42 796. In the first stage, the tough phase a2) is obtained and is composed of lower alkyl acrylates to an extent of at least 50% by weight, preferably to an extent of more than 80% by weight, which gives rise to a glass transition temperature T_{mg} of this phase of below −10° C. The crosslinking monomers a22) used are (meth)acrylic esters of diols, for example ethylene glycol dimethacrylate or 1,4-butanediol dimethacrylate, aromatic compounds having two vinyl or allyl groups, for example divinylbenzene, or other crosslinkers having two ethylenically unsaturated, free-radically polymerizable radicals, for example allyl methacrylate as a graftlinker. Examples of crosslinkers having three or more unsaturated, free-radically polymerizable groups, such as allyl groups or (meth)acryloyl groups, include triallyl cyanurate, trimethylolpropane triacrylate and trimethacrylate, and pentaerythrityl tetraacrylate and tetramethacrylate. Further examples for this purpose are given in U.S. Pat. No. 4,513,118.

The ethylenically unsaturated, free-radically polymerizable monomers specified under a23) may, for example, be acrylic or methacrylic acid and their alkyl esters having 1-20 carbon atoms, provided that they have not yet been mentioned, where the alkyl radical may be linear, branched or cyclic. In addition, a23) may comprise further free-radically polymerizable aliphatic comonomers which are copolymerizable with the alkyl acrylates a21). However, significant fractions of aromatic comonomers such as styrene, alpha-methylstyrene or vinyltoluene should remain excluded, since they lead to undesired properties of the moulding material A, in particular in the event of weathering.

In obtaining the tough phase in the first stage, the particle size and its polydispersity must be set carefully. The particle size of the tough phase depends essentially on the concentration of the emulsifier. Advantageously, the particle size can be controlled by the use of a seed latex. Particles having a mean particle size (weight-average) below 130 nm, preferably below 70 nm, and having a polydispersity U₈₀ below 0.5 (U₈₀ is calculated from an integral treatment of the particle size distribution which is determined by ultracentrifuge. U₈₀=[(r₉₀−r₁₀)/r₅₀]−1, where r₁₀, r₅₀, r₉₀=mean integral particle radius for which 10, 50, 90% of the particle radii are below and 90, 50, 10% of the particle radii are above this value) preferably below 0.2, are achieved with emulsifier concentrations of from 0.15 to 1.0% by weight based on the water phase. This is the case in particular for anionic emulsifiers, for example the particularly preferred alkoxylated and sulphated paraffins. The polymerization initiators used are, for example, from 0.01 to 0.5% by weight of alkali metal peroxodisulphate or ammonium peroxodisulphate, based on the water phase, and the polymerization is triggered at temperatures of from 20 to 100° C. Preference is given to using redox systems, for example a combination of from 0.01 to 0.05% by weight of organic hydroperoxide and from 0.05 to 0.15% by weight of sodium hydroxymethylsulphinate, at temperatures of from 20 to 80° C.

The hard phase a1) bonded covalently to the tough phase a2) at least to an extent of 15% by weight has a glass transition temperature of at least 70° C. and may be composed exclusively of methyl methacrylate. As comonomers a12), up to 20% by weight of one or more further ethylenically unsaturated, free-radically polymerizable monomers may be present in the hard phase, and alkyl(meth)acrylates, preferably alkyl acrylates having 1 to 4 carbon atoms, are used in such amounts that the glass transition temperature does not go below that mentioned above.

The polymerization of the hard phase a1) proceeds, in a second stage, likewise in emulsion using the customary assistants, as are also used, for example, for the polymerization of the tough phase a2).

In a preferred embodiment, the hard phase comprises low molecular weight and/or copolymerized UV absorbers in amounts of from 0.1 to 10% by weight, preferably from 0.5 to 5% by weight, based on A as a constituent of the comonomeric components a12) in the hard phase. Examples of polymerizable UV absorbers, as described, inter alia, in U.S. Pat. No. 4,576,870, include 2-(2′-hydroxyphenyl)-5-methacryloylamidobenzotriazole or 2-hydroxy-4-methacryloyloxybenzophenone. Low molecular weight UV absorbers may, for example, be derivatives of 2-hydroxy-benzophenone or of 2-hydroxyphenylbenzotriazole or phenyl salicylate. In general, the low molecular weight UV absorbers have a molecular weight of less than 2×10³ (g/mol). Particular preference is given to UV absorbers with low volatility at the processing temperature and homogeneous miscibility with the hard phase a1) of the polymer A.

Blends with poly(meth)acrylates as the main component

In addition, it is possible to use mixtures of PMMA with further polymers compatible with PMMA. Examples of polymers compatible with PMMA include ABS polymers or SAN polymers.

The PMMA polymer moulding materials are traded under the PLEXIGLAS® brand by Evonik Röhm GmbH.

The PMMA polymer moulding materials and the further polymer moulding materials are typically coloured by means of a colour masterbatch or with liquid dye.

The Polycarbonates

Polycarbonates are known in the technical field. Polycarbonates can be considered formally as polyesters formed from carbonic acid and aliphatic or aromatic dihydroxyl compounds. They are readily obtainable by reacting diglycols or bisphenols with phosgene or carbonic diesters, by polycondensation or transesterification reactions.

Preference is given in this context to polycarbonates which derive from bisphenols. These bisphenols include especially 2,2-bis(4-hydroxyphenyl)propane (bisphenol A), 2,2-bis(4-hydroxyphenyl)butane (bisphenol B), 1,1-bis(4-hydroxyphenyl)cyclohexane (bisphenol C), 2,2′-methylenediphenol (bisphenol F), 2,2-bis(3,5-dibromo-4-hydroxyphenyl)propane (tetrabromobisphenol A) and 2,2-bis(3,5-dimethyl-4-hydroxyphenyl)propane (tetramethylbisphenol A).

Typically, such aromatic polycarbonates are prepared by interfacial polycondensation or transesterification, details being given in Encycl. Polym. Sci. Engng. 11, 648-718.

In interfacial polycondensation, the bisphenols are emulsified as an aqueous, alkaline solution in inert organic solvents, for example methylene chloride, chlorobenzene or tetrahydrofuran, and reacted with phosgene in a stage reaction. The catalysts used are amines, and in the case of sterically hindered bisphenols also phase transfer catalysts. The resulting polymers are soluble in the organic solvents used.

The properties of the polymers can be varied widely through the selection of the bisphenols. In the case of simultaneous use of different bisphenols, it is also possible to form block polymers in multistage polycondensations.

The Colorants

The following colorant groups can be used according to the inventive teaching:
1. organic colour pigments, for example diazo dyes, phthalocyanines, perylenes, anthraquinones,
2. organic soluble dyes, for example anthrapyrimidines, quinophthalone, perinones, or monoazo dyes, for example Thermoplastrot® 454, Macrolexgelb® G, Sandoplast® Rot G or Solvaperm® Rot G,
3. mixture of 1 and 2,
4. inorganic pigments (for example zinc chromate, cadmiumsulphide, chromium oxide, ultramarine pigments and metal flakes, and also BaSO₄ and TiO₂)
5. mixture of 1, 2 and 4, and
6. carbon black

The amount of colorant may be in the range from 0.5% by weight to 50% by weight, based on the total amounts of the colorant preparation.

The Polyacrylate

The polyacrylate used is, for example, a polyacrylate which is traded under the EFKA®-4550 brand by Ciba Specialty Chemicals. The polymer consists essentially of the monomers alpha-methylstyrene, 2-ethylhexyl acrylate and MPEG methacrylate.

The modified polyacrylate is used in the form of an aqueous solution with an active substance content in the range from 48% by weight to 52% by weight.

The amount of polyacrylate may be between 5% by weight and 50% by weight, based on the total amount of the colorant preparation.

The polyacrylate is used as a pH-independent dispersant for pigment deflocculation in aqueous coating systems and pigment concentrates.

Further Assistants

In addition, all customary assistants can optionally be added to the colorant preparation, for example agents for preventing decay, bacterial decomposition, fungicides, levelling aids and defoamers.

To establish the optimal viscosity of the colorant composition, for example, demineralized water is used.

The thermoplastic moulding material can be coloured either directly by adding the colorant preparation to an uncoloured polymer moulding material, or via a masterbatch.

A masterbatch is understood to mean a formulation composed of the colorant preparation and a polymer moulding material, the concentration of the colorant preparation in the masterbatch being established so as to give rise to the desired colour impression when the masterbatch is used to colour uncoloured polymer moulding materials.

### EXAMPLES

Production of the Coloured Thermoplastic Polymer Moulding Material

Colouring with Colorant Preparation

Examples 1 to 4 were produced in the following manner:

Polymer granule and colorant preparation were used in a tumbling mixer to produce a mixture which was metered by means of a funnel into the intake zone of a single-screw extruder. The venting zones were attached to a vacuum pump. A granulator was connected downstream of the extruder. In a second processing step, specimens for the Vicat softening temperature determination were injection-moulded from the granules thus obtained.

### Comparative Example 1 for Colouring with Organic Binder (Fatty Acid Ester)

Composition:
Colorant:
   0.06% by weight of Thermoplastrot® 454
   0.016% by weight of Macrolexgelb® G
0.3% by weight of octadecenoic acid, present to an extent of approx. 70 mol % as an oligoethylene glycol mono- and diester, the remaining 30% being esterified with sugars/sugar alcohols
99.62% by weight of PLEXIGLAS® 8N moulding material

Vicat softening temperature: 106° C.

For comparison:

Vicat softening temperature of the PLEXIGLAS® 8N moulding material comprising 0.06% by weight of Thermoplastrot® 454 and 0.016% by weight of Macrolexgelb® G without C18 fatty acid: 107° C.

Injection moulding on a Battenfeld BA 350CD:

Injection time: 1.76 sec

Material temp.: 250° C.

Cylinder temp.: 250 to 230° C.

Mould temp.: 68° C.

Switch from injection to hold pressure at internal mould pressure 560 bar

Total cycle time: 50 sec

Injection moulding with open venting cylinder

After 30 shots, severe mould deposits and red dye deposition

### Example 2: Addition of Pure Waterborne Binder without Colour Pigments

Composition:
0.32% by weight of distilled water
0.17% by weight of EFKA® 4550 (50% aqueous mod. polyacrylate)
0.01% by weight of defoamer
0.0006% by weight of antidecay agent
99.5% by weight of PLEXIGLAS® 8N moulding material

Injection moulding on Arburg 221: no deposit formation

Injection time: 1.5 sec

Material temp.: 250° C.

Cylinder temp.: 250 to 225° C.

Mould temp.: 68° C.

Path-dependent switch from injection to hold pressure

Total cycle time: 30 sec

Injection moulding with open venting cylinder

In this experiment, no Vicat softening temperature increase was observed; the Vicat softening temperature was 107° C. both with and without binder.

### Example 3: Colouring with Thermoplastrot 454 in the Form of a Waterborne Liquid Dye

Composition:
0.193% by weight of distilled water
0.1% by weight of EFKA® 4550 (50% aqueous mod. polyacrylate)
0.006% by weight of defoamer
0.00035% by weight of antidecay agent
0.2% by weight of Thermoplastrot® 454
99.5% by weight of PLEXIGLAS® 8N moulding material

Injection moulding on Battenfeld BA 350CD: no deposit formation

Injection time: 1.77 sec

Material temp.: 248° C.

Cylinder temp.: 250 to 230° C.

Mould temp.: 68° C.

Switch from injection to hold pressure at internal mould

pressure 565 bar

Total cycle time: 50 sec

Injection moulding with open venting cylinder

Compared to uncoloured PLEXIGLAS® 8N moulding material, the Vicat softening temperature increased by 2.5° C. from 106° C. to 108.5° C.

### Example 4: Colouring with Paliotogelb® K2270 in the Form of a Waterborne Liquid Dye

Composition:
0.193% by weight of distilled water
0.1% by weight of EFKA® 4550 (50% aqueous mod. polyacrylate)
0.006% by weight of defoamer
0.00035% by weight of antidecay agent
0.2% by weight of Paliotogelb® K2270 (Pigment Yellow 183)
99.5% by weight of PLEXIGLAS® 8N moulding material

Injection moulding on Battenfeld BA 350CD: no deposit formation

Injection time: 1.76 sec

Material temp.: 250° C.

Cylinder temp.: 250 to 230° C.

Mould temp.: 68° C.

Switch from injection to hold pressure at internal mould pressure 560 bar

Total cycle time: 50 sec

Injection moulding with open venting cylinder

Compared to uncoloured PLEXIGLAS® 8N moulding material, the Vicat softening temperature increased by 2.5° C. from 106° C. to 108.5° C.

The liquid dyes according to Example 5 and Example 6 were each applied by drum application (tumbling mixer) to an extent of 0.5% by weight to PLEXIGLAS® 8N, and compounded on a 30 mm Stork single-screw extruder at 230° C. There was no vacuum on the open vacuum zone. On injection moulding of the compounds on an Arburg 221, no mould deposits were observed.

Injection time: 1.5 sec

Material temp.: 250° C.

Cylinder temp.: 250 to 225° C.

Mould temp.: 68° C.

Path-dependent switch from injection moulding to hold pressure

Total cycle time: 30 sec

Injection moulding with open venting cylinder

The Vicat softening temperature of the moulding material remained constant at 108° C.

### Example 5

| Name | Amounts (in % by weight) |
|---|---|
| EFKA ® 4550 | 20 |
| Demineralized water | 38.74 |
| Byk ® 024 | 1.2 |
| Sandoplast ® Rot G | 6.87 |
| Blanc Fix N | 31.54 |
| Kronos ® 2220 | 1.580 |
| (titanium dioxide) | |
| Ebotec ® MT 15 | 0.07 |

### Example 6

| Name | Amounts (in % by weight) |
|---|---|
| EFKA ® 4550 | 20 |
| Demineralized water | 38.73 |
| Byk ® 024 | 0.6 |
| Kronos ® 2220 | 40.0 |
| (titanium dioxide) | |
| Ebotec ® MT 15 | 0.07 |

The titanium dioxide was dispersed before addition on a drum mill.

The results show that the Vicat softening temperature is not reduced but in some cases increased, and that, on injection moulding of the thermoplastic polymer moulding material coloured with the inventive colorant preparation, no deposits form on the injection moulds.

The Vicat softening temperature of the polymers was determined in ISO 306.

1. (canceled)

2. A method of making a colored thermoplastic polymer product, the method comprising adding a colorant preparation to a molten uncoloured thermoplastic polymer composition during injection molding or extrusion of the uncoloured thermoplastic polymer to produce a thermoplastic polymer product with the colorant preparation is within the matrix of the thermoplastic polymer, wherein the colorant preparation comprises 1% by weight to 49% by weight of a modified polyacrylate in the form of a 48% by weight to 52% by weight aqueous solution, 0.5% by weight to 50% by weight of a colorant or of a colorant mixture, 0% by weight to 50% by weight of one or more further additives and demineralized water, where the portions by weight of the components add up to 100% by weight.

3. The method of claim 2, wherein the colorant or colorant mixture comprises an organic colour pigment, an organic soluble dye, an inorganic pigment, a mixture of an organic colour pigment, an organic soluble dye, and an inorganic pigment, or carbon black.

4. The method of claim 2, wherein the colorant or colorant mixture comprises at least one organic pigment selected from the group consisting of a diazo dye, phthalocyanine, perylene, and anthraquinone.

5. The method of claim 2, wherein the colorant or colorant mixture comprises at least one organic soluble dye selected from the group consisting of anthrapyrimidine, quinophthalone, perinone, and a monoazo dye.

6. The method of claim 2, wherein the colorant or colorant mixture comprises at least one inorganic pigment selected from the group consisting of zinc chromate, cadmium sulphide, chromium oxide, an ultramarine pigment, metal flakes, BaSO₄, and TiO₂.

7. The method of claim 2, which is an impact modified poly(meth)acrylate.
